(19) United States
(12) Patent Application Publication
(10) Pub. No.: US 2007/0152382 A1
(43) Pub. Date: Jul. 5, 2007

(54) Transporting apparatus and method for manufacturing honeycomb structured body

(76) Inventors: Hiroshi Yamada, Gifu (JP); Eiji Sumiya, Gifu (JP); Kosei Tajima, Gifu (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/638,433

(22) Filed: Dec. 14, 2006

(30) Foreign Application Priority Data
Dec. 27, 2005 (JP) PCT/JP05/23955

(51) Int. Cl. C04B 33/32

(52) U.S. Cl. 264/628

(57) ABSTRACT

A transporting apparatus of the present invention comprises a storage unit for temporarily storing a wet mixture and a transporting unit equipped with a conveyor for transporting the wet mixture.

### CROSS-REFERENCE TO RELATED APPLICATIONS

This application claims priority of PCT/JP2005/023955 filed on Dec. 27, 2005. The contents of this application are incorporated herein by reference in their entirety.

### BACKGROUND OF THE INVENTION

1. Field of the Invention

The present invention relates to a transporting apparatus and a method for manufacturing a honeycomb structured body.

2. Discussion of the Background

In recent years, particulates such as soot contained in exhaust gases that are discharged from internal combustion engines of vehicles, such as buses and trucks, and construction machines, have raised serious problems as contaminants harmful to the environment and the human body.

For this reason, various honeycomb filters using honeycomb structural bodies comprising porous ceramics, which serve as filters that capture particulates in exhaust gases to purify the exhaust gases, have been proposed.

Conventionally, upon manufacturing such a honeycomb filter, first, a ceramic powder, an organic binder, a dispersant solution and the like are mixed to prepare a wet mixture. Then, the wet mixture is continuously extrusion-molded through a die, and the extruded molded body is cut into a predetermined length so that a rectangular pillar-shaped honeycomb molded body is manufactured.

Next, the resulting honeycomb molded body is dried by utilizing a microwave drying apparatus or a hot-air drying apparatus, and after predetermined cells have been sealed so that either one of ends of each cell is sealed by the plug material layer, degreasing and firing are carried out on the resulting honeycomb molded body to manufacture a honeycomb fired body.

Thereafter, a sealing material paste is applied to the side faces of the honeycomb fired body, and the honeycomb fired bodies are mutually bonded so that an aggregate body of the honeycomb fired bodies, in which a number of the honeycomb fired bodies are bound to one another by interposing the sealing material layer (adhesive layers), is manufactured. Next, the resulting aggregate body of the honeycomb fired bodies is cut and machined into a predetermined shape, such as a cylindrical shape and a cylindroid shape, by using a cutting tool or the like so that a ceramic block is formed, and lastly, a sealing material paste is applied onto the periphery of the ceramic block to form a sealing material layer (coat layer); thus, the manufacturing of the honeycomb filter is completed.

In the manufacturing method of this kind, after a wet mixture has been prepared, it is necessary to transport the wet mixture to an extrusion-molding machine at the next process through a transporting apparatus.

Examples of the transporting apparatus used for transporting the wet mixture include, for example, those disclosed in JP-A 2002-255353 and JP-A H05-131432.

The contents of JP-A 2002-255353 and JP-A H05-131432 are incorporated herein by reference in their entirety.

### SUMMARY OF THE INVENTION

The transporting apparatus of the present invention comprises a storage unit for temporarily storing a wet mixture and a transporting unit equipped with a conveyor for transporting the wet mixture.

Desirably, the transporting apparatus comprises a plurality of storage units as the above-mentioned storage unit, and the wet mixture is desirably distributed to and stored in each of the storage units. In this case, distribution of the wet mixture is desirably carried out by changing the transport direction of the conveyor.

Moreover, the conveyor is desirably a belt conveyor, a chain conveyor, a pallet conveyor, a trolley conveyor, a flow conveyor, a flight conveyor, a disc conveyor, a power screw, or a screw conveyor.

The transporting unit is desirably constituted by a casing and a belt conveyor installed in the casing.

Here, a belt constituting the belt conveyor is desirably a flat belt, or a belt with a bridge. Moreover, the material of the belt is desirably rubber, urethane, vinyl chloride, fluororesin, or silicone resin.

In the transporting apparatus, the wet mixture is transported to an extrusion-molding machine, and desirably the storage unit may be able to store the wet mixture in the amount of at least about 1.5 times and at most about 3 times (weight conversion) higher than the molding capability of the extrusion-molding machine.

Furthermore, the transporting apparatus stores the wet mixture for a fixed period of time, and the storing time is desirably at least about 1 hour and at most about 10 hours, and more desirably in the range of about 4 hours to about 8 hours.

A method for manufacturing a honeycomb structured body according to the present invention comprises: transporting a wet mixture containing inorganic powders and an organic binder that have been wet-mixed, to an apparatus used in extrusion molding; followed by manufacturing a pillar-shaped honeycomb molded body having a number of cells longitudinally placed in parallel with one another with a cell wall therebetween through extrusion molding; and firing the above-mentioned honeycomb molded body to manufacture a honeycomb structured body comprising a honeycomb fired body, and in the transport of the wet mixture, a transporting apparatus, which comprises a storage unit for temporarily storing the wet mixture and a transporting unit equipped with a conveyor for transporting the wet mixture, is utilized so that the wet mixture is transported to an extrusion-molding machine.

In the method for manufacturing a honeycomb structured body, the transporting apparatus comprises a plurality of storage units as the above-mentioned storage unit, and the wet mixture is desirably distributed to and stored in each of the storage units, and then the wet mixture is transported from the respective storage units to an apparatus used in different extrusion molding processes. In this case, distribution of the wet mixture is desirably carried out by changing the transport direction of the conveyor.

Here, the conveyor is desirably a belt conveyor, a chain conveyor, a pallet conveyor, a trolley conveyor, a flow conveyor, a flight conveyor, a disc conveyor, a power screw, or a screw conveyor.

In the method for manufacturing a honeycomb structured body, the transporting unit constituting the transporting apparatus desirably comprises a casing and a belt conveyor installed in the casing.

Here, a belt constituting the belt conveyor is desirably a flat belt, or a belt with a bridge. Also, the material of the belt is desirably rubber, urethane, vinyl chloride, fluororesin, or silicone resin.

Moreover, in the method for manufacturing a honeycomb structured body, desirably the storage unit may be able to store the wet mixture in the amount of at least about 1.5 times and at most about 3 times (weight conversion) higher than the molding capability of an apparatus used in the extrusion molding.

Furthermore, in the method for manufacturing a honeycomb structured body, the wet mixture is stored for a fixed period of time, and the storing time is desirably at least about 1 hour and at most about 10 hours, and more desirably in the range of about 4 hours to about 8 hours.

### BRIEF DESCRIPTION OF THE DRAWINGS

FIG. 1 is a cross-sectional view that schematically shows one example of a transporting apparatus according to one embodiment of the present invention.

FIG. 2A is a cross-sectional view that schematically shows another example of the transporting apparatus according to one embodiment of the present invention; and FIG. 2B is a bottom face view of a storage unit constituting the transporting apparatus shown in FIG. 2A.

FIG. 3 is a cross-sectional view that schematically shows another example of the transporting apparatus according to one embodiment of the present invention.

FIG. 4A is a plan view that schematically shows one example of a conveyor which forms one component of the transporting apparatus according to one embodiment of the present invention, and FIG. 4B is a cross-sectional view of FIG. 4A.

FIG. 5A is a plan view that schematically shows another example of the conveyor constituting the transporting apparatus according to one embodiment of the present invention, and FIG. 5B is a cross-sectional view of FIG. 5A.

FIG. 6 is a perspective view that schematically shows one example of a honeycomb structured body according to one embodiment of the present invention.

FIG. 7A is a perspective view that schematically shows a honeycomb fired body constituting the honeycomb structured body shown in FIG. 6, and FIG. 7B is a cross-sectional view taken along line A-A of FIG. 7A.

FIG. 8 is a graph showing the relationship between storing times and molding pressures of a wet mixture in Examples 1 to 5 and Comparative example 1.

### DESCRIPTION OF THE EMBODIMENTS

The transporting apparatus according to one embodiment of the present invention comprises a storage unit for temporarily storing a wet mixture and a transporting unit equipped with a conveyor for transporting the wet mixture.

In the transporting apparatus according to one embodiment of the present invention, a wet mixture is reliably transported to an apparatus used in the next process. In addition to this, even in the case where the mixture cannot be continuously supplied due to troubles in processes after the transport of the wet mixture, since the wet mixture may become able to be temporarily stored in the storage unit, foregoing processes, i.e. processes for preparing the wet mixture, may not need to be stopped and may be able to be continued, and therefore, it may become possible to prevent deterioration of the operational efficiency.

A method for manufacturing a honeycomb structured body according to one embodiment of the present invention comprises: transporting a wet mixture containing inorganic powders and an organic binder that have been wet-mixed, to an apparatus used in extrusion molding; followed by manufacturing a pillar-shaped honeycomb molded body having a number of cells longitudinally placed in parallel with one another with a cell wall therebetween through extrusion molding; and firing the above-mentioned honeycomb molded body to manufacture a honeycomb structured body comprising a honeycomb fired body, and in the transport of the wet mixture, a transporting apparatus, which comprises a storage unit for temporarily storing the wet mixture and a transporting unit equipped with a conveyor for transporting the wet mixture, is utilized so that the wet mixture is transported to an extrusion-molding machine.

In the method for manufacturing a honeycomb structured body according to one embodiment of the present invention, since the transporting apparatus according to one embodiment of the present invention is used, the prepared wet mixture may become able to be transported to an extrusion-molding machine used in the next process. In addition to this, even in the case where production lines in the next and the following processes, which will be described below, are stopped due to troubles, since the wet mixture may become able to be temporarily stored in the storage unit installed in the transporting apparatus, the prior processes, i.e. processes for preparing the wet mixture, may not need to be stopped and may become able to be continuously operated.

Moreover, in the method for manufacturing a honeycomb structured body according to one embodiment of the present invention, upon transport of a prepared wet mixture, the wet mixture is desirably stored in the storage unit for a fixed period of time (for example, at least about 1 hour and at most about 10 hours). This arrangement improves the moldability of the wet mixture in the following extrusion-molding process.

Although the reason for this has not been clarified, it is presumed that, since the wet mixture is aged, the organic binder is allowed to swell during the aging time so that the organic binder becomes to be able to wrap around the inorganic particles (silicon carbide particles), and as a result, chances of contact between inorganic particles and a die used for extrusion molding can be reduced, improving the lubrication characteristics, and thus a molding pressure is lowered.

When the wet mixture is stored for a fixed period of time, although the storing time is not particularly limited, the lower limit of the storing time is desirably set to about 1 hour, more desirably about 4 hours, and the upper limit of the storing time is desirably set to about 10 hours, more desirably set to about 8 hours.

In the case where the storing time is about 1 hour or more, the moldability of the wet mixture may tend to be improved, and when the storing time is about 10 hours or less, partial drying of the wet mixture becomes less likely to occur, and deterioration of the moldability tends not to occur.

Here, when the moldability of the wet mixture is improved, the molding pressure at the time of extrusion molding may become able to be reduced, and with a reduced molding pressure, the occurrence of defective molding may become able to be reduced. Furthermore, the life of wear parts (metal die and the like) constituting the extrusion-molding machine may become able to be prolonged.

First, a transporting apparatus according to embodiments of the present invention will be described.

The transporting apparatus according to the embodiment of the present invention comprises a storage unit for temporarily storing the wet mixture and a transporting unit equipped with a conveyor for transporting the wet mixture

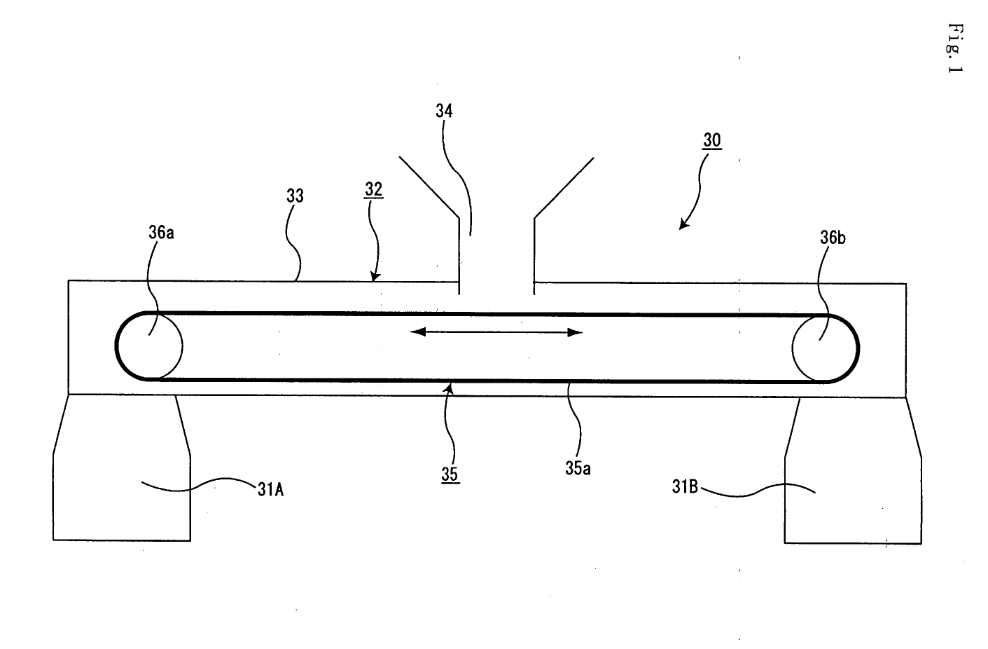

FIG. 1 is a cross-sectional view that schematically shows one example of the transporting apparatus according to one embodiment of the present invention.

This transporting apparatus 30 is constituted by storage units 31A and 31B used for temporarily storing a wet mixture, a casing 33 having a supplying port 34 through which the wet mixture is charged, and a transporting unit 32 that is constituted by a belt conveyor 35 and is used for transporting the wet mixture.

In the transporting apparatus 30, when a wet mixture, prepared in a wet mixing machine (not shown), is charged into the transporting unit 32 through the supplying port 34, the supplied wet mixture is accumulated on the belt conveyor 35 that constitutes the transporting unit 32.

The belt conveyor 35, which is constituted by a belt 35a and rollers 36a and 36b, transports a wet mixture (not shown) accumulated on the belt conveyor 35, toward the storage unit 31A continuously or intermittently, and charges the mixture into the storage unit 31A.

The storage unit 31A has a discharging port that can be opened and closed at its bottom face, and the storage unit 31A may become able to temporarily store a fixed amount of the wet mixture and also may become able to charge the wet mixture through the discharging port into an apparatus used in the next process, for example, a process for manufacturing a molded body by using an extrusion-molding machine, while controlling the amount of the wet mixture to a fixed amount per unit time.

Moreover, by reversing the rotational direction of the rollers 36a and 36b, the transporting apparatus 30 may become able to transport the wet mixture accumulated on the belt conveyor 35 to the storage unit 31B continuously or intermittently so as to charge the wet mixture into the storage unit 31B.

In the same manner as the storage unit 31A, the storage unit 31B, which also has a discharging port that can be opened and closed at its bottom face, may become able to temporarily store a fixed amount of the wet mixture, and charge the wet mixture into the next process, while controlling the amount of the wet mixture to a fixed amount per unit time.

Accordingly, in the transporting apparatus 30 having a plurality of storage units, the wet mixture may become able to be distributed to each of the storage units 31A and 31B, and further the wet mixture may become able to be stored at each of the storage units 31A and 31B. Moreover, in the transporting apparatus 30, distribution of the wet mixture is to be carried out by changing (reversing) the transport direction of a belt conveyor 35. In the distribution of the wet mixture according to a method of this kind, the apparatus may become able be easily controlled and the wet mixture may become able to be easily distributed.

Furthermore, since the wet mixture may become able to be distributed, the process of manufacturing the wet mixture, i.e., the manufacturing process before the transporting apparatus may become able to be performed in a single production line, and the manufacturing processes after the transporting apparatus, for example, an extrusion molding process using the wet mixture, may become able to be performed in two or more production lines, and therefore, efficient production lines may be able to be established.

Here, in the case where the transporting apparatus 30 supplies the wet mixture into two separate extrusion-molding machines, the amount to be respectively delivered may be able to be selected by adjusting the speed of the belt conveyor or the respective driving time period or the like of the forward and reverse rotations. Here, as to what amount of the wet mixture is transported to which storage unit, the selection can be made on demand.

In this manner, in the transporting apparatus 30, since it may become possible for the storage units 31A and 31B to function as buffers, the wet mixing machine (not shown) in the process prior to the transporting apparatus 30 is allowed to continuously carry out the mixing, and the wet mixture may be able to be continuously charged into the transporting apparatus 30; thus, even in the case where the operation of any process in the next process and thereafter is stopped, the state as it is may be able to be maintained if only for a short period of time.

In contrast, in the case where no wet mixture is charged into the transporting apparatus 30 due to a stoppage of the mixing operation in the wet mixing machine, so that the wet mixture needs to be supplied to the next process, also, the wet mixture may be able to be continuously supplied to the extrusion-molding machine.

Moreover, in the transporting apparatus 30, the wet mixture may become able to be temporarily stored in the storage units 31A and 31B.

The transporting apparatus 30 is provided with a casing 33 having a lid, which covers the entire periphery of the belt conveyor 35 so as to be able to produce a tightly sealed state in which the storage units 31A and 31B are included. With this configuration, it may become possible to carry out the transporting and storing processes, while keeping the moisture content of the wet mixture in a fixed state.

Here, in the transporting apparatus according to embodiments of the present invention, the transporting unit is not necessarily required to have a casing; however, from the viewpoint of quality maintenance of the wet mixture, the transporting unit is desirably provided with a casing, and in particular, from the viewpoint that the above-mentioned effects may become easier to be enjoyed, it is more desirable that a casing having a lid is provided.

Therefore, as shown in FIG. 1, the transporting unit desirably comprises a casing and a belt conveyor placed inside the casing.

Here, in the transporting apparatus according to embodiments of the present invention, the casing having a lid of course includes a casing constituted by a box-shaped member having a lid, as well as a casing that has been preliminarily formed into a tube shape.

Moreover, in the transporting apparatus 30, the moisture content of the wet mixture is desirably controlled so that the moisture content variation of the wet mixture is set to about 1% by weight or less, and by using the casing with a lid, it may become possible to control the moisture content in this manner. This arrangement is desirable, because the rate of occurrence of defective products in the post process tends to become smaller as the moisture content variation of the wet mixture is reduced.

Here, the moisture content of the wet mixture is desirably set to at least about 10.0% by weight and at most about 20.0% by weight when the wet mixture is used in the method for manufacturing a honeycomb structure described below. This is because such moisture content is suitable for manufacturing a honeycomb molded body of a predetermined shape by extrusion molding.

The transporting apparatus 30 shown in FIG. 1 is a transporting apparatus having a configuration in which a wet mixture is distributed to and stored at different storage units, and distribution of the wet mixture may be able to be carried out by reversing the transport direction of a belt conveyor installed in the transporting unit.

However, the configuration of the transporting apparatus according to embodiments of the present invention is not intended to be limited by this configuration, and may have, for example, the following configuration.

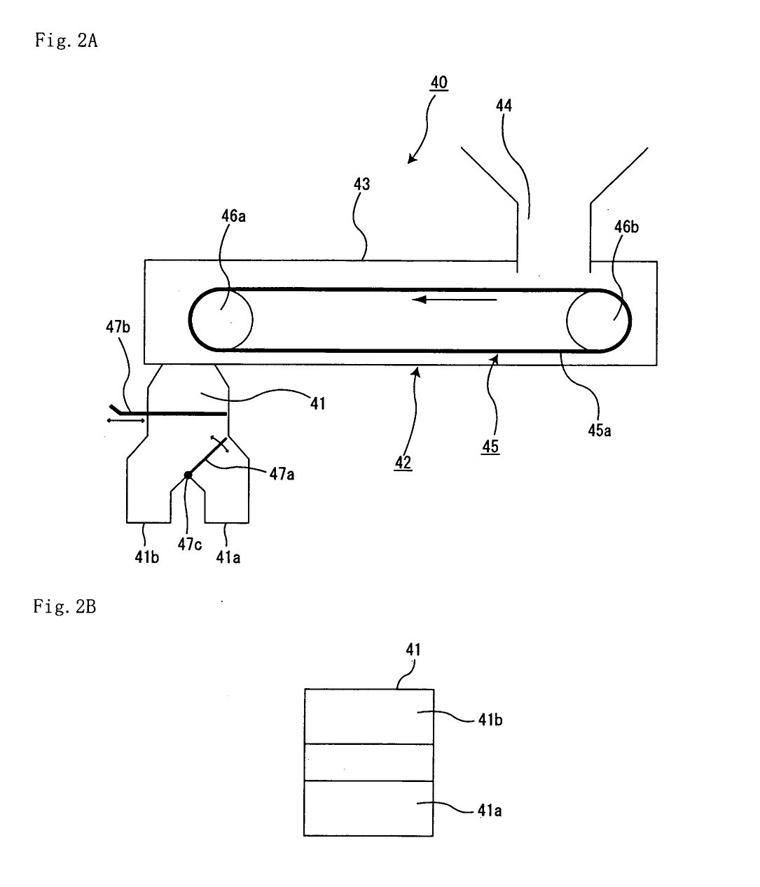

FIG. 2A is a cross-sectional view that schematically shows another example of the transporting apparatus according to one embodiment of the present invention, and FIG. 2B is a bottom face view of a storage unit that constitutes the transporting apparatus shown in FIG. 2A.

A transporting apparatus 40 shown in FIGS. 2A and 2B is a transporting apparatus by which a wet mixture may become able to be transported to different ends, and in this transporting apparatus 40, the wet mixture is to be distributed in a storage unit 41, as is different from the transporting apparatus 30 shown in FIG. 1. In other words, the transporting apparatus 40 comprises the storage unit 41 used for temporarily storing the wet mixture, and a transporting unit 42 which transports the wet mixture, including a casing 43 having a supplying port 44 through which the wet mixture is charged and a belt conveyor 45.

Here, when the wet mixture prepared in the wet mixing machine (not shown) is charged into the transporting unit 42 through the supplying port 44, the wet mixture is accumulated on the belt conveyor 45 that constitutes the transporting unit 42. The belt conveyor 45, which is constituted by a belt 45a and rollers 46a and 46b, transports the wet mixture accumulated on the belt conveyor 45 toward the storage unit 41 continuously or intermittently, and charges the wet mixture into the storage unit 41. The storage unit 41 may be able to temporarily store a fixed amount of the wet mixture, and also may be able to charge the wet mixture into the next process, while controlling the amount thereof to a fixed amount per unit time.

The storage unit 41 is provided with a closing plate 47b capable of sliding laterally, and when this closing plate 47b is closed (state shown in FIG. 2A), the inner space of the storage unit 41 may be able to be divided into the upper and the lower parts.

Here, the lower part separated by the closing plate 47b of the storage unit 41 is provided with two discharging ports 41a and 41b on its bottom face, which may make it possible for only either one of the discharging ports to discharge the wet mixture.

In other words, a shaft member 47c is rotatably attached to a branch portion between the discharging port 41a side and the discharging port 41b side, and one side of a plate-shaped switching plate 47a is secured to the shaft member 47c so that the switching plate 47a can be shifted at a predetermined angle in association with the rotation of the shaft member 47c, and by changing the position of the switching plate 47a, the wet mixture may be able to be distributed.

In the storage unit 41 of this kind, when the closing plate 47b is closed, the wet mixture, transported from the transporting unit 42, may be able to be stored in the storage unit 41.

Moreover, in the case where the closing plate 47b is pulled out to be in an open state, the wet mixture may be able to be transported to an apparatus used in the next process through the discharging port. Here, by placing the switching plate 47a at such a position (see FIG. 2A) as to plug the discharging port 41a side, the wet mixture stored on the closing plate 47b may be able to be transported to an apparatus used in the next process through the discharging port 41b. Moreover, in the case where the position of the switching plate 47a is shifted to such a position as to plug the discharging port 41b side, the stored wet mixture may be able to be transported to an apparatus used in the next process through the discharging port 41a.

Therefore, in the storage unit 41, it may become possible to temporarily store the wet mixture by closing the closing plate, and by selecting which discharging port to be opened (closed) using the switching plate, it may become possible for the wet mixture to be distributed and transported to an apparatus used in the next process.

Here, in the storage unit 41, the switching plate 47a may be placed at a position that covers neither of the discharging ports so that the wet mixture may be simultaneously transported to an apparatus used in the next process through both of the discharging ports 41a and 41b.

Moreover, for example, a charging port of an extrusion-molding machine to be used in the next process is placed right below the discharging port 41a or 41b.

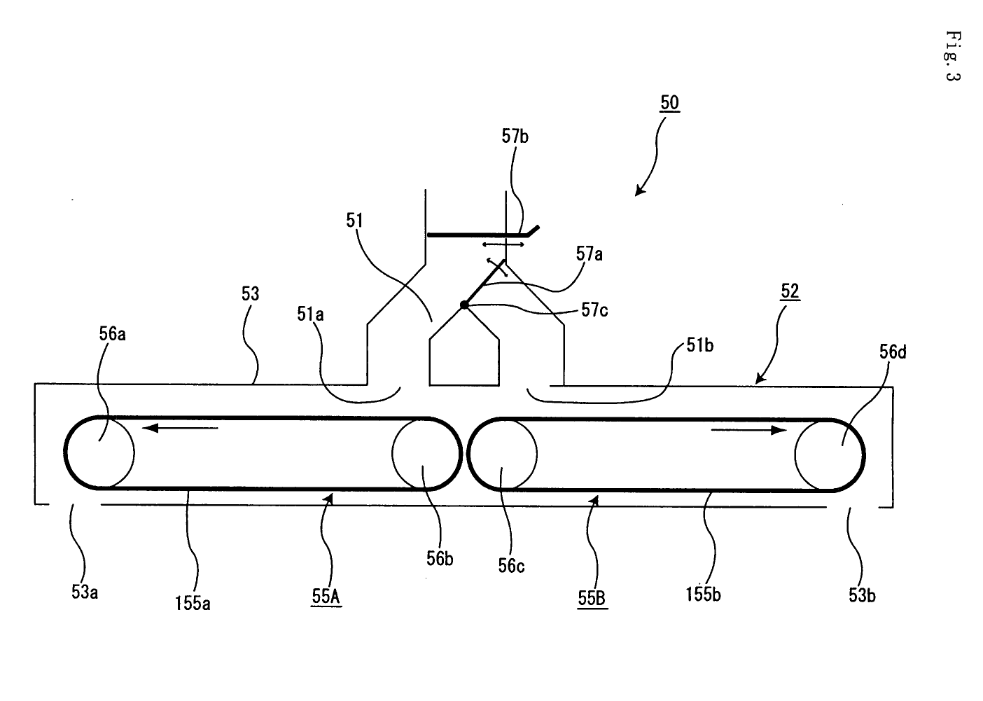

FIG. 3 is a cross-sectional view that schematically shows still another example of the transporting apparatus according to one embodiment of the present invention.

A transporting apparatus 50 shown in FIG. 3 is a transporting apparatus provided with a transporting unit and a storage unit; however, this transporting apparatus 50 is different from the transporting apparatus 30 shown in FIG. 1 in that the storage unit is placed on the upper stream side from the transporting unit in the transporting path of the wet mixture.

In other words, the transporting apparatus 50 comprises a storage unit 51 used for temporarily storing the wet mixture, and a transporting unit 52 for transporting the wet mixture, which is constituted by a casing 53 and belt conveyors 55A and 55B, and a charging port formed on the upper face of the casing 53 is used for charging the wet mixture into the casing 53, is allowed to communicate with discharging ports 51a and 51b formed on the lower face of the storage unit 51.

The storage unit 51 is provided with a closing plate 57b capable of sliding laterally, and when this closing plate 57b is closed (state shown in FIG. 3), the inner space of the storage unit 51 may be able to be divided into the upper and the lower parts.

Here, the lower section separated by the closing plate 57b of the storage unit 51 is provided with two discharging ports 51a and 51b on its bottom face, which may make it possible for only either one of the discharging ports to discharge the wet mixture.

In other words, a shaft member 57c is rotatably attached to a branch portion between the discharging port 51a side and the discharging port 51b side, and one side of a plate-shaped switching plate 57a is secured to the shaft member 57c so that the switching plate 57a can be shifted to a predetermined angle in association with the rotation of the shaft member 57c, and by changing the position of the switching plate 57a, the wet mixture may be able to be discharged.

Moreover, a belt conveyor 55A, including a belt 155a and rollers 56a and 56b, and a belt conveyor 55B including a belt 155b and rollers 56c and 56d, are placed inside the casing 53, and the respective belt conveyors are designed so as to be able to transport the wet mixture toward the end sides of the casing 53.

Here, in the transporting apparatus 50, the wet mixture, prepared in the wet mixing machine (not shown), is charged into the storage unit 51, and the wet mixture is temporarily stored on the closing plate 57b, if necessary, and then charged into the casing 53 through the opened discharging port to be accumulated on the belt conveyor. In other words, in the case where the discharging port 51a of the storage unit 51 is open, the wet mixture is accumulated on the belt 155a, while, in the case where the discharging port 51b is open, the wet mixture is accumulated on the belt 155b.

Here, the configuration for storing the wet mixture in the storage unit 51 and the configuration for discharging the wet mixtures through either of the discharging port, are the same as those configurations provided in the storage unit 41 shown in FIG. 2A.

Therefore, the transporting apparatus 50 may be able to temporarily store the wet mixture on the upstream side of the transporting unit.

Moreover, in the transporting apparatus 50, the wet mixture may be able to be distributed in the storage unit 51.

The wet mixtures, accumulated on the respective belts 155a and 155b, are transported toward predetermined directions by the belt conveyors, and then charged into the next process through the discharging ports 53a and 53b formed in the casing 53.

In this manner, the transporting apparatus according to embodiments of the present invention may have a storage unit on the upper stream side of the transporting unit.

Each of the transporting apparatuses according to embodiments of the present invention that have been explained by reference to FIGS. 1 to 3 is a transporting apparatus equipped with a storage unit on either the upstream side or the downstream side of the transporting unit; however, it is only necessary for the transporting apparatus according to embodiments of the present invention to include at least one transporting unit and one storage unit, and for example, storage units may be installed on both of the upstream side and the downstream side of the transporting unit.

Moreover, the transporting apparatuses according to embodiments of the present invention that have been explained by reference to FIGS. 1 to 3 have a configuration in which the wet mixture is distributed at either the storage unit or the transporting unit; however, the transporting apparatus according to one embodiment of the present invention may have a configuration in which the wet mixture is distributed at both of the units.

Moreover, in the case where the wet mixture may be able to be distributed in the transporting apparatus according to embodiments of the present invention, the distribution ends are not limited to two places, and may be prepared as two or more places.

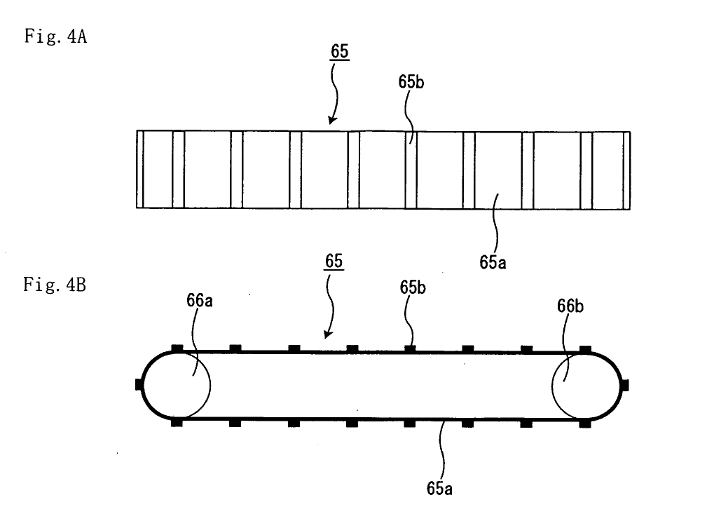

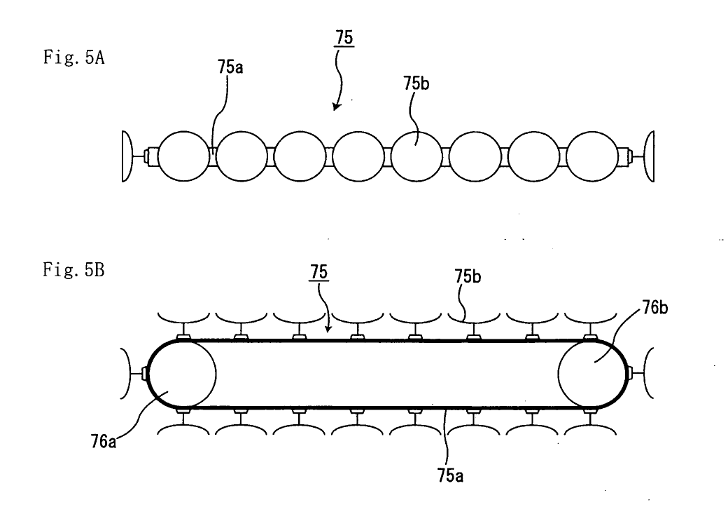

The transporting apparatuses according to the embodiments of the present invention shown in FIGS. 1 to 3 are equipped, as a conveyor, with a belt conveyor using a flat belt; however, the conveyor to be used in the transporting apparatus of the present invention is not limited thereto, and may include, for example, conveyors as shown in FIGS. 4A, 4B, 5A and 5B.

Each of FIGS. 4A and 5A is a plan view that schematically shows another example of a conveyor constituting the transporting apparatus according to the embodiments of the present invention, and each of FIGS. 4B and 5B is a cross-sectional view of each of FIGS. 4A and 5A, respectively.

A conveyor 65, shown in FIGS. 4A and 4B is equipped with a belt 65a with a bridge and rollers 66a and 66b, and the belt 65a with a bridge has a plate-shaped protruding member 65b that is placed virtually perpendicularly to the advancing direction of the belt. Here, although not shown in the figures, the transporting unit constituted by the conveyor 65 may be of course equipped with a casing.

Additionally, by using a flat belt or a belt with a bridge, the maintenance and control may become easier.

Moreover, a conveyor 75, shown in FIGS. 5A and 5B, is a chain conveyor with buckets, which is equipped with a chain with buckets 75a and rollers 76a and 76b, and a bucket 75b used for holding the wet mixture is secured on the surface of the chain with buckets 75a with predetermined intervals. Although not shown in the figures, the transporting unit, constituted by the conveyor 75, may of course have a casing.

When a casing is provided, the rate of change in moisture content can be more easily reduced, and thus it may become possible to keep the moisture content of the wet mixture at a constant level.

The conveyors, shown in FIGS. 4A, 4B, 5A and 5B, may be also able to be preferably used as the transporting unit constituting the transporting apparatus according to the embodiments of the present invention.

With respect to the material for the belt, although not particularly limited, examples thereof include: rubber, urethane, vinyl chloride and resins such as fluororesin and silicone resin. By using those belts made of a resin material, the wet mixture tends not to adhere to the belt, and thus it may become possible to reliably transport a predetermined amount of the wet mixture. Moreover, the weight of the apparatus itself may be able to be reduced, so that installation thereof may become easier.

Moreover, in addition to the belt conveyor, the transporting apparatus according to embodiments of the present invention may use, for example, a chain conveyor, a pallet conveyor, a trolley conveyor, a flow conveyor, a flight conveyor, a disc conveyor, a power screw, a screw conveyor and the like as a conveyor constituting the transporting unit. By using those conveyors, it may become possible to transport a predetermined amount of wet mixture in a continuous manner.

Since the purpose of the transporting apparatus according to embodiments of the present invention is not only to provide a material mixture in a continuous manner, in the case where the succeeding process after transporting the material mixture by the transporting apparatus is stopped due to any trouble, although the supply of the material needs to be stopped, it is not necessary to stop the operation of the transporting apparatus itself, and in addition, it is also not necessary to stop the preceding processes before the transporting apparatus, that is, the process of preparing the material mixture and the like. Consequently, if one process is stopped, it is not necessary to stop all the processes, and therefore, deterioration in the operation efficiency tends not to be caused.

Moreover, in the case where the supply of the wet mixture to the transporting apparatus is once stopped, immediately after resuming the operation of the extrusion-molding machine again, the molding machine sometimes has an insufficient supply of the wet mixture and, in such a case, the extruded molded body may become a defective product, however, by using the transporting apparatus according to the embodiment of the present invention, occurrence of such defective products may be able to be prevented.

In other words, in the transporting apparatus according to embodiments of the present invention, even in the case where the operation is stopped due to any trouble or the like in a process after the transporting apparatus to cause a failure in continuously supplying the wet mixture, since a storage unit which may be able to temporarily store the wet mixture is provided there, it is not necessary to stop processes before the transporting apparatus (preparation of the wet mixture, and the like), and the processes may become able to be continuously operated so that it may become possible to prevent degradation of the operation efficiency.

Moreover, since the transporting apparatus according to the embodiments of the present invention is equipped with the storage unit, a required amount of the wet mixture may be able to be always transported to an apparatus used in the succeeding process, and therefore, when the molding machine is stopped temporarily and then re-operated, a molded body having a desired shape may be able to be immediately supplied to an apparatus used in the succeeding process.

The following description will discuss a method for manufacturing a honeycomb structured body according to embodiments of the present invention.

The method for manufacturing a honeycomb structured body according to one embodiment of the present invention comprises: transporting a wet mixture containing inorganic powders and an organic binder that have been wet-mixed to an apparatus used in extrusion-molding, followed by manufacturing a pillar-shaped honeycomb molded body having a number of cells longitudinally placed in parallel with one another with a cell wall therebetween through extrusion molding, and firing the honeycomb molded body to manufacture a honeycomb structured body comprising a honeycomb fired body. In this method, a transporting apparatus, which comprises a storage unit for temporarily storing the wet mixture and a transporting unit equipped with a conveyor for transporting the wet mixture, is utilized in the transport so that the wet mixture is transported to an extrusion-molding machine.

A honeycomb structured body manufactured by the method for manufacturing a honeycomb structured body according to the embodiment of the present invention as mentioned above may be able to be used as, for example, a honeycomb filter.

The following description will discuss a honeycomb structured body that may be able to be used as a honeycomb filter by reference to figures.

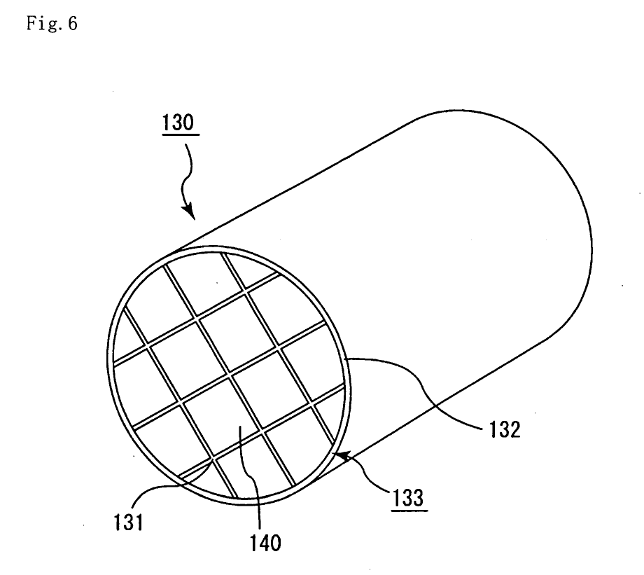

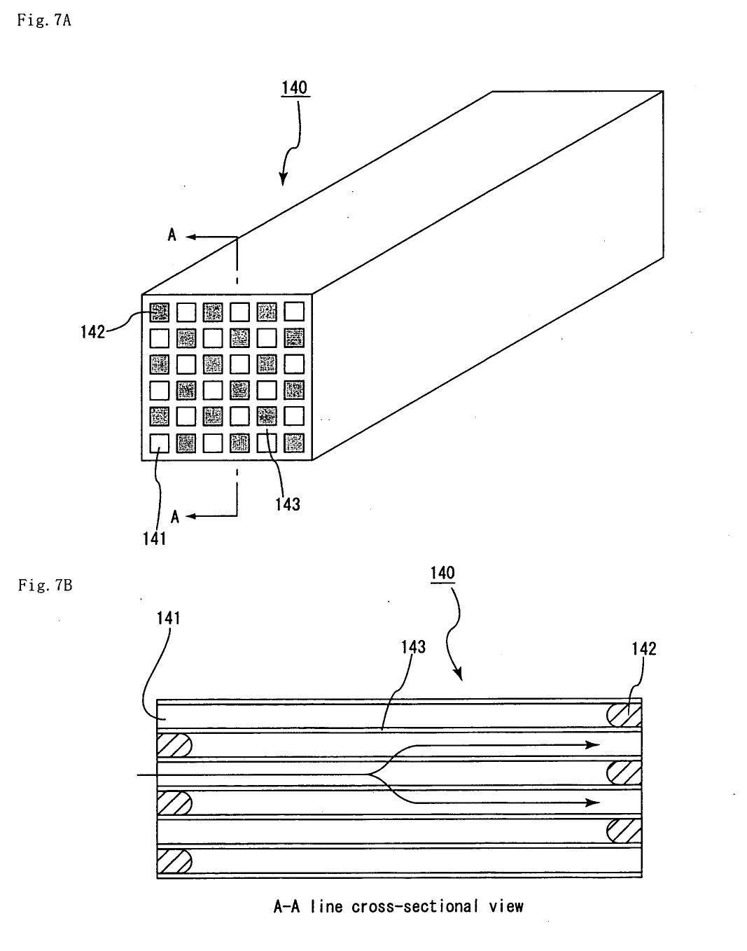

FIG. 6 is a perspective view that schematically shows one example of a honeycomb structured body of this kind, FIG. 7A is a perspective view that schematically shows a honeycomb fired body constituting the honeycomb structured body, and FIG. 7B is a cross-sectional view taken along line A-A of FIG. 7A.

In a honeycomb filter 130, a plurality of honeycomb fired bodies 140 shown in FIGS. 7A and 7B are bonded to one another by interposing a sealing material layer (adhesive layers) 131 to form a ceramic block 133, and a sealing material layer (coat layer) 132 is further formed on the outer circumference of this ceramic block 133.

Moreover, as shown in FIGS. 7A and 7B, a honeycomb fired body 140 has a number of cells 141 longitudinally placed in parallel with one another, so that each cell wall 143 that separates the cells 141 is allowed to function as a filter.

In other words, as shown in FIG. 7B, each of the cells 141, formed in the honeycomb fired body 140, is sealed with a plug material layer 142 at either one of ends on its exhaust-gas inlet side and outlet side so that exhaust gases that have entered one cell 141 are discharged from another cell 141 after having surely passed through each cell wall 143 that separates the cells 141; thus, when exhaust gases pass through the cell wall 143, particulates are captured by the cell wall 143 so that the exhaust gases are purified.

The following description will discuss the method for manufacturing the honeycomb structured body according to one embodiment of the present invention in the order of processes.

Here, the following description will discuss a method for manufacturing a honeycomb structured body by using silicon carbide powders as inorganic powders, with reference to an example of a method for manufacturing a honeycomb structured body which is mainly composed of silicon carbide as constituent material.

Of course, the main component of the constituent materials for the honeycomb structured body is not limited to silicon carbide, and other examples thereof include: nitride ceramic materials, such as aluminum nitride, silicon nitride, boron nitride and titanium nitride, carbide ceramic materials, such as zirconium carbide, titanium carbide, tantalum carbide and tungsten carbide, and oxide ceramic materials, such as alumina, zirconia, cordierite, mullite, and aluminum titanate.

Among these, non-oxide ceramic materials are desirably used, and in particular, silicon carbide is more desirably used. Silicon carbide is desirable because of its superior heat resistant characteristics, mechanical strength, thermal conductivity and the like. Here, materials, such as a silicon-containing ceramic material manufactured by blending metal silicon in the above-mentioned ceramic material and a ceramic material that is combined by silicon or a silicate compound, may also be used as the constituent materials, and among these, a material manufactured by blending silicon carbide with metal silicon (silicon-containing silicon carbide) is desirably used.

First, inorganic powders, such as silicon carbide powders having different average particle sizes, and an organic binder are dry-mixed to prepare a mixed powder, and a liquid-state plasticizer, a lubricant and water are mixed to prepare a mixed liquid, and the mixed powder and the mixed liquid are mixed by using a wet-mixing device so that a wet mixture for use in manufacturing a molded body is prepared.

With respect to the particle size of the silicon carbide powder, although not particularly limited, those which are less susceptible to shrinkage in the succeeding firing are desirably used, and for example, a mixed powder, prepared by combining 100 parts by weight of powder having an average particle size of at least about 0.3 μm and at most about 50 μm with at least about 5 parts by weight and at most about 65 parts by weight of powder having an average particle size of at least about 0.1 μm and at most about 1.0 μm, is desirably used.

In order to adjust the pore diameter and the like of the honeycomb fired body, it is necessary to adjust the firing temperature; whereas by adjusting the particle size of the inorganic powder, the pore diameter may be able to be adjusted.

With respect to the above-mentioned binder, although not particularly limited, examples thereof include: methylcellulose, carboxy methylcellulose, hydroxy ethylcellulose, polyethylene glycol and the like. Among these, methylcellulose is more desirably used.

In general, the compounding amount of the above-mentioned binder is desirably set to at least about 1 part by weight and at most about 10 parts by weight with respect to 100 parts by weight of the silicon carbide powder.

With respect to the above-mentioned plasticizer, although not particularly limited, for example, glycerin and the like may be used.

Moreover, with respect to the lubricant, although not particularly limited, for example, polyoxy alkylene-based compounds, such as polyoxyethylene alkyl ether and polyoxy propylene alkyl ether, may be used.

Specific examples of the lubricant include: polyoxyethylene monobutyl ether and polyoxypropylene monobutyl ether.

Here, the plasticizer and the lubricant are not necessarily contained in the mixed material powder depending on cases.

Upon preparing the wet mixture, a dispersant solution may be used, and with respect to the dispersant solution, examples thereof include: water, an organic solvent such as benzene, and an alcohol such as methanol.

Moreover, a molding auxiliary may be added to the wet mixture.

With respect to the molding auxiliary, although not particularly limited, examples thereof include: ethylene glycol, dextrin, fatty acid, fatty acid soap, polyalcohol and the like.

Furthermore, balloons that are fine hollow spheres comprising oxide-based ceramics and a pore forming agent such as spherical acrylic particles or graphite may be added to the above-mentioned material paste, if necessary.

With respect to the above-mentioned balloons, although not particularly limited, examples thereof include alumina balloons, glass micro-balloons, shirasu balloons, fly ash balloons (FA balloons), mullite balloons and the like may be used. Among these, alumina balloons are more desirably used.

Here, with respect to the wet mixture using silicon carbide powder prepared as described above, the temperature thereof is desirably set to about 28° C. or less. When the temperature is too high, the organic binder tends to be gelatinized.

Moreover, the rate of organic components in the wet mixture is desirably set to about 10% by weight or less, and the content of moisture is desirably set to at least about 8.0% by weight and at most about 20.0% by weight.

The wet mixture, which has been prepared, is then transported, and charged into a molding machine.

In the method for manufacturing a honeycomb structured body according to embodiments of the present invention, the transport of the wet mixture is carried out by a transporting apparatus that is equipped with a storage unit used for temporarily storing the wet mixture and a transporting unit for transporting the wet mixture.

More specifically, the transporting apparatus according to the embodiment of the present invention that has been explained earlier may be able to be used.

The transporting apparatus according to one embodiment of the present invention to be used here is desirably one having a storage unit which is designed to be able to store the wet mixture in the amount of at least about 1.5 times and at most about 3 times (weight conversion) higher than the molding capability of the extrusion-molding machine.

When the amount of the wet mixture that can be stored is within the above range, it is suitable for supplying a wet mixture to an extrusion-molding machine in a continuous manner, while also keeping the wet mixture for a fixed period of time.

After the wet mixture transported by the transporting apparatus has been charged into the extrusion-molding machine, it is extrusion-molded into a pillar-shaped honeycomb molded body having a number of cells longitudinally placed in parallel with one another with a cell wall therebetween.

Next, the resulting honeycomb molded body is dried by using a drying apparatus, such as a microwave drying apparatus, a hot-air drying apparatus, a dielectric drying apparatus, a reduced-pressure drying apparatus, a vacuum drying apparatus and a freeze drying apparatus.

In the present specification, the shape indicated by the word “pillar” refers to any desired shape of a pillar including a round pillar, an oval pillar, a polygonal pillar and the like.

Next, depending on the needs, ends on the outlet side of a group of cells on the inlet side and ends on the inlet side of a group of cells on the outlet side are filled with a predetermined amount of plug material paste that is to form plugs so as to seal those cells.

With respect to the plug material paste, although not particularly limited, those plug material pastes that allow the plugs formed through post processes to have a porosity of at least about 30% and at most about 75% are desirably used, and, for example, the same material as that of the wet mixture may be able to be used.

Next, by carrying out degreasing (for example, at a temperature of at least about 200° C. and at most about 500° C.) and firing (for example, at a temperature of at least about 1400° C. and at most about 2300° C.) on the honeycomb molded body, which has the plug material paste filled therein and has been dried, under predetermined conditions, it may become possible to manufacture a honeycomb fired body in which a plurality of cells are longitudinally placed in parallel with one another with a cell wall therebetween, and either one of ends of the cells is sealed.

With respect to the conditions for degreasing and firing the honeycomb molded body, conventional conditions that have been used upon manufacturing a filter comprising a porous ceramic material may be able to be adopted.

Next, a sealing material paste to form a sealing material layer is applied onto a side face of the honeycomb fired body with an even thickness to form a sealing material paste layer, and lamination of another honeycomb fired body on the sealing material paste layer is successively repeated so that an aggregate body of honeycomb fired bodies having a predetermined size is manufactured.

With respect to the sealing material paste, for example, those comprising inorganic fibers and/or inorganic particles in addition to an inorganic binder and an organic binder may be used.

With respect to the inorganic binder, for example, silica sol, alumina sol and the like may be used. Each of these may be used alone or two or more kinds of these may be used in combination. Among the inorganic binders, silica sol is more desirably used.

With respect to the organic binder, examples thereof include polyvinyl alcohol, methyl cellulose, ethyl cellulose, carboxymethyl cellulose, and the like. Each of these may be used alone or two or more kinds of these may be used in combination. Among the organic binders, carboxymethyl cellulose is more desirably used.

With respect to the inorganic fibers, examples thereof include ceramic fibers, such as silica-alumina, mullite, alumina and silica, and the like. Each of these may be used alone or two or more kinds of these may be used in combination. Among the inorganic fibers, alumina fibers are more desirably used.

With respect to the inorganic particles, examples thereof include carbides and nitrides, and specific examples include inorganic powder comprising silicon carbide, silicon nitride and boron nitride, and the like. Each of these may be used alone, or two or more kinds of these may be used in combination. Among the inorganic particles, silicon carbide having superior thermal conductivity is desirably used.

Moreover, balloons that are fine hollow spheres comprising oxide-based ceramics and a pore forming agent such as spherical acrylic particles or graphite may be added to the above-mentioned sealing material paste, if necessary.

With respect to the above-mentioned balloons, although not particularly limited, examples thereof include alumina balloons, glass micro-balloons, shirasu balloons, fly ash balloons (FA balloons) and mullite balloons may be used. Among these, alumina balloons are more desirably used.

This aggregate body of honeycomb fired bodies is heated so that the sealing material paste layers are dried and solidified to form sealing material layers (adhesive layers).

Next, cutting by using a diamond cutter or the like is carried out on the aggregate body of honeycomb fired bodies in which a plurality of honeycomb fired bodies are bonded to one another by interposing a sealing material layer (adhesive layers) so that a cylindrical-shaped ceramic block is manufactured.

Then, a sealing material layer is formed on the outer circumference of the ceramic block by using the above-mentioned sealing material paste so that a honeycomb structured body, in which a plurality of honeycomb fired bodies are bound to one another by interposing a sealing material layer (adhesive layers), with a sealing material layer (coat layer) being formed on the outer circumference of a cylindrical-shaped ceramic, may be able to be manufactured.

Thereafter, a catalyst is supported on the honeycomb structured body on demand. The supporting process of the catalyst may be carried out on the honeycomb structural bodies prior to being manufactured into an aggregate body.

In the case where a catalyst is supported thereon, desirably, an alumina film having a high specific surface area is formed on the surface of the honeycomb structured body, and a co-catalyst and a catalyst such as platinum are applied to the surface of this alumina film.

Examples of the method for forming the alumina film on the surface of the honeycomb structured body include a method in which the honeycomb structured body is impregnated with a solution of a metal compound containing aluminum such as Al (NO₃)₃ and then heated, and a method in which the honeycomb structured body is impregnated with a solution containing alumina powder and then heated, and the like.

With respect to the method for applying a co-catalyst to the alumina film, for example, a method in which the honeycomb structured body is impregnated with a solution of a metal compound containing a rare-earth element, such as Ce(NO₃)₃, and then heated is proposed.

Examples of the method for applying a catalyst to the alumina film include: a method in which the ceramic fired body is impregnated with a nitric acid solution of diamine dinitro platinum ([Pt(NH₃)₂(NO₂)₂]HNO₃: about 4.53% by weight in platinum concentration) or the like and then heated, and the like.

Moreover, the catalyst may be applied in such a manner that a catalyst is preliminarily applied to alumina particles and the honeycomb structured body is impregnated with a solution containing the alumina powder to which the catalyst has been applied, and then heated.

The method for manufacturing the honeycomb structured body described above relates to a method for manufacturing a honeycomb structured body (hereinafter, referred to as aggregated honeycomb structured body) having a structure in which a plurality of honeycomb fired bodies are bonded to one another by interposing a sealing material layer (adhesive layer); however, the honeycomb structured body to be manufactured by the manufacturing method according to embodiments of the present invention may be a honeycomb structured body in which a cylindrical-shaped ceramic block is constituted by a single honeycomb fired body (hereinafter, referred to as integral honeycomb structured body).

For manufacturing the integral honeycomb structured body of this kind, first, a honeycomb molded body is manufactured by using the same method as that used for manufacturing the aggregated honeycomb structured body, except that the size of the honeycomb molded body to be formed through extrusion-molding is larger in comparison with that of the aggregated honeycomb structured body.

Here, the method for transporting, storing and the like of the wet mixture prior to the molding are the same as those methods used for the aggregated honeycomb structured body; therefore, the description thereof will be omitted.

In the same manner as the method for manufacturing the aggregated honeycomb structured body, the honeycomb molded body is dried by using a drying apparatus, such as a microwave drying apparatus, a hot-air drying apparatus, a dielectric drying apparatus, a reduced-pressure drying apparatus, a vacuum drying apparatus and a freeze drying apparatus to form a ceramic dried body. Next, depending on the needs, ends on the outlet side of a group of cells on the inlet side and ends on the inlet side of a group of cells on the outlet side are filled with a predetermined amount of plug material paste that is to form plugs so as to seal those cells.

Thereafter, in the same manner as the manufacturing of the aggregated honeycomb structured body, the degreasing and firing are carried out to manufacture a ceramic block, and by forming a sealing material layer (coat layer), if necessary, an integral honeycomb structured body may be able to be manufactured. Moreover, a catalyst may be supported on the integral honeycomb structured body by using the same method.

In accordance with the method for manufacturing a honeycomb structured body according to the embodiments of the present invention as explained above, it may become possible to manufacture a honeycomb structured body with a high operating efficiency.

Moreover, upon manufacturing a honeycomb structured body through the above-mentioned method, a sequence of manufacturing processes may be carried out through a single production line; however, for example, the processes up to the process of charging the wet mixture by using a transporting apparatus which may be able to distribute the wet mixture may be carried out through a single production line, and then the manufacturing of a molded body by using an extrusion-molding machine and processes thereafter may be carried out through two or more production lines.

In this case, the wet mixture may be appropriately distributed and supplied to respective production lines by using the transporting apparatuses 30, 40, and 50 shown in FIG. 1, FIG. 2A and FIG. 3.

In this specification, description has so far been made mainly with respect to a method for manufacturing a honeycomb structured body in which either one of the ends of each cell is sealed so that it may be able to be used as a honeycomb filter, and a transporting apparatus usable in this manufacturing method. In addition, the transporting apparatus and the method for manufacturing a honeycomb structured body according to the embodiments of the present invention may be able to be preferably used for the manufacture of a honeycomb structured body which can be used as a catalyst supporting carrier, i.e., a honeycomb structured body in which ends of cells are not sealed.

In the method for manufacturing a honeycomb structured body according to embodiments of the present invention, even in the case where the operation is stopped due to any trouble or the like in a process after the process of transporting the wet mixture, since a transporting apparatus equipped with a storage unit which may be able to temporarily store the wet mixture is utilized as the transporting apparatus, it is not necessary to stop processes before the transporting apparatus (process for preparing the wet mixture, and the like), and the processes may become able to be continuously operated and therefore it may become possible to prevent degradation of the operation efficiency.

Moreover, since the transporting apparatus is equipped with the storage unit, a required amount of the wet mixture may be able to be always transported to an extrusion-molding machine in the succeeding process; therefore, when the extrusion-molding machine is stopped temporarily and then re-operated, a molded body having a desired shape may be able to be immediately supplied.

### EXAMPLES

With respect to the method for manufacturing a honeycomb structured body using the transporting apparatus of the present invention, in the case where a wet mixture had been stored in the transporting apparatus for a fixed period of time, and then a molded body of a predetermined shape was manufactured by using an extrusion-molding machine, the relationship between the storing period of time in the transporting apparatus (storage unit) and the molding pressure (MPa) was evaluated.

Here, in the respective examples, the molding rate was set to 4000 mm/min, and the molding pressure was adjusted so that the honeycomb molded body could be formed at this molding rate.

### Example 1

Powder of α-type silicon carbide having an average particle size of 10 μm (250 kg), powder of α-type silicon carbide having an average particle size of 0.5 μm (100 kg) and an organic binder (methylcellulose) (20 kg) were mixed to prepare a mixed powder.

Next, separately, a lubricant (UNILUB, made by NOF Corp.) (12 kg), a plasticizer (glycerin) (5 kg) and water (65 kg) were mixed to prepare a liquid mixture, and this liquid mixture and the mixed powder were mixed by using a wet mixer to prepare a wet mixture.

The moisture content of the wet mixture thus prepared was 14% by weight.

Next, this wet mixture was transported to an extrusion-molding machine by using the transporting apparatus of the present invention shown in FIG. 1. Although the transporting apparatus shown in FIG. 1 may be able to distribute the wet mixture to different extrusion-molding machines, the wet mixture was not distributed in this example, and the wet mixture, charged through a charging port 34, was transported to a storage unit 31A via a belt conveyor.

Thereafter, the wet mixture was stored in the storage unit 31A for one hour, and this was then charged into a material charging port of the extrusion-molding machine placed right under the storage unit 31A.

Here, the moisture content of the wet mixture immediately before the charging into the extrusion-molding machine was 13.5% by weight.

The wet mixture was then extrusion-molded into a molded body having a shape shown in FIGS. 7A and 7B. The molding pressure in this example was 9.0 MPa.

Next, after the raw molded body had been dried by using a microwave drying apparatus or the like, predetermined cells were filled with a plug material paste having the same composition as the wet mixture.

After having been again dried by using a drying apparatus, the resulting product was degreased at 400° C., and fired at 2200° C. in a normal-pressure argon atmosphere for 3 hours to manufacture a honeycomb fired body comprising a silicon carbide sintered body with a porosity of 42%, an average pore diameter of 12.5 μm, a size of 34.3 mm×34.3 mm×150 mm, the number of cells (cell density) of 46.5/cm² and a thickness of each cell wall of 0.20 mm.

By using a heat resistant sealing material paste containing 30% by weight of alumina fibers having an average fiber length of 20 μm, 21% by weight of silicon carbide particles having an average particle size of 0.6 μm, 15% by weight of silica sol, 5.6% by weight of carboxymethyl cellulose and 28.4% by weight of water, a large number of the honeycomb fired bodies were bonded to one another, and then dried at 120° C. and cut by using a diamond cutter to manufacture a cylindrical-shaped ceramic block with a sealing material layer (adhesive layer) having a thickness of 1 mm.

Next, silica-alumina fibers (average fiber length: 100 μm, average fiber diameter: 10 μm) (23.3% by weight) serving as inorganic fibers, silicon carbide powder having an average particle size of 0.3 μm (30.2% by weight) serving as inorganic particles, silica sol (content of SiO₂ in sol: 30% by weight) (7% by weight) serving as an inorganic binder, carboxymethyl cellulose (0.5% by weight) serving as an organic binder and water (39% by weight) were mixed, and kneaded to prepare a sealing material paste.

Thereafter, by using the above-mentioned sealing material paste, a sealing material paste layer having a thickness of 0.2 mm was formed on the outer circumference of the ceramic block. This sealing material paste layer was then dried at 120° C. so that a honeycomb structured body 10 having a cylindrical shape (143.8 mm in diameter×150 mm in length) with a sealing material layer (coat layer) formed on the outer circumference was manufactured.

### Examples 2 to 5

By using the same method as Example 1 except that the storing time in the transporting apparatus (storage unit) was set to the period of time shown in Table 1, a honeycomb structured body was manufactured.

In each of the examples, each of molding pressures (MPa) also shown in Table 1 was required upon extrusion molding.

### Comparative Example 1

By using the same method as Example 1, except that the storage unit was not provided and the wet mixture was not temporarily stored, a honeycomb structured body was manufactured.

In this Comparative example, the molding pressure (MPa) also shown in Table 1 was required upon extrusion molding.

TABLE 1

| | Storing time (hr) | Molding pressure (MPa) |
|---|---|---|
| Example 1 | 1 | 9.0 |
| Example 2 | 4 | 6.0 |
| Example 3 | 8 | 7.0 |
| Example 4 | 10 | 8.5 |
| Example 5 | 12 | 11.0 |
| Comparative example 1 | 0 | 10.0 |

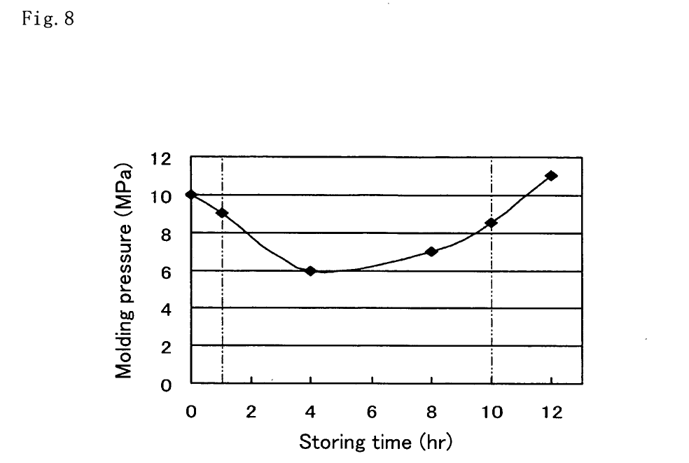

As clearly indicated by the results shown in Table 1 and FIG. 8, by storing the wet mixture in the transporting apparatus (storage unit) for about 1 hour to about 10 hours prior to conducting the extrusion molding, it may become possible to reduce the molding pressure.

Moreover, in particular, by setting the storing time to about 4 hours to about 8 hours, the molding pressure may be able to be further reduced to 7 MPa or less.

In this manner, by reducing the molding pressure upon extrusion molding, it may become possible to reduce the rate of occurrence of defective molded products, and it also may become possible to make the extrusion-molding metal mold hardly wear, and consequently to prolong the life of the metal die.

In contrast, in the case where the wet mixture was not stored in the transporting apparatus (storage unit) temporarily as indicated by Comparative example 1, as well as in the case where the wet mixture was stored for a long period of time, such as 10 hours or more, as indicated by Example 5, it was necessary to use a greater molding pressure (10 MPa or more) upon extrusion molding.

Moreover, it was revealed from those results that desirably the wet mixture was temporarily stored in the transporting apparatus, and the desirable period of time for temporarily storing the wet mixture was set to at least about 1 hour and at most about 10 hours.

FIG. 8 is a graph showing the relationship between storing times and molding pressures of a wet mixture in Examples 1 to 5 and Comparative example 1.

The reason that those results were obtained from the above-mentioned Examples and Comparative example is presumably because, when the wet mixture was stored in the transporting apparatus (storage unit) for a fixed period of time as shown in Examples 1 to 4, the wet mixture was aged so that this aging allowed methylcellulose to swell as mentioned above, thereby improving the lubrication characteristics among silicon carbide particles.

However, when the storing time is too long as in the case of Example 5, it is presumed that the wet mixture is partially dried to cause a reduction in the moldability, and as a result, the molding pressure is increased.

What is claimed as new and desired to be secured by Letters Patent of the United States is:

1. A transporting apparatus comprising:
a storage unit for temporarily storing a wet mixture; and
a transporting unit equipped with a conveyor for transporting said wet mixture.

2. The transporting apparatus according to claim 1,
wherein
said storage unit comprises a plurality of storage units, and
said wet mixture is distributed to and stored in each of the storage units.

3. The transporting apparatus according to claim 2,
wherein
distribution of said wet mixture is carried out by changing the transport direction of said conveyor.

4. The transporting apparatus according to claim 1,
wherein
said conveyor is a belt conveyor, a chain conveyor, a pallet conveyor, a trolley conveyor, a flow conveyor, a flight conveyor, a disc conveyor, a power screw, or a screw conveyor.

5. The transporting apparatus according to claim 1,
wherein
said transporting unit is constituted by a casing and a belt conveyor installed in said casing.

6. The transporting apparatus according to claim 5,
wherein
a belt constituting said belt conveyor is a flat belt, or a belt with a bridge.

7. The transporting apparatus according to claim 5,
wherein
the material of said belt is rubber, urethane, vinyl chloride, fluororesin, or silicone resin.

8. The transporting apparatus according to claim 1,
wherein
said wet mixture is transported to an extrusion-molding machine, and
said storage unit can store the wet mixture in the amount of at least about 1.5 times and at most about 3 times higher, by weight, than the molding capability of said extrusion-molding machine.

9. The transporting apparatus according to claim 1,
wherein
said wet mixture is stored for a fixed period of time, and
the storing time is at least about 1 hour and at most about 10 hours.

10. The transporting apparatus according to claim 9,
wherein
said storing time is in the range of about 4 hours to about 8 hours.

11. A method for manufacturing a honeycomb structured body, comprising:
transporting a wet mixture containing inorganic powders and an organic binder that have been wet-mixed, to an apparatus used in extrusion molding; followed by
manufacturing a pillar-shaped honeycomb molded body having a number of cells longitudinally placed in parallel with one another with a cell wall therebetween through extrusion molding; and
firing said honeycomb molded body to manufacture a honeycomb structured body comprising a honeycomb fired body,
wherein
a transporting apparatus, which comprises a storage unit for temporarily storing the wet mixture and a transporting unit equipped with a conveyor for transporting said wet mixture, is utilized in said transport of the wet mixture so that said wet mixture is transported to an extrusion-molding machine.

12. The method for manufacturing a honeycomb structured body according to claim 11,
wherein
said storage unit comprises a plurality of storage units, and
said wet mixture is distributed to and stored in each of the storage units, and then transported from each storage unit to apparatuses used in different extrusion-molding processes.

13. The method for manufacturing a honeycomb structured body according to claim 12,
wherein
distribution of said wet mixture is carried out by changing the transport direction of said conveyor.

14. The method for manufacturing a honeycomb structured body according to claim 11,
wherein
said conveyor is a belt conveyor, a chain conveyor, a pallet conveyor, a trolley conveyor, a flow conveyor, a flight conveyor, a disc conveyor, a power screw, or a screw conveyor.

15. The method for manufacturing a honeycomb structured body according to claim 11,
wherein
said transporting unit is constituted by a casing and a belt conveyor installed in said casing.

16. The method for manufacturing a honeycomb structured body according to claim 15,
wherein
a belt constituting said belt conveyor is a flat belt, or a belt with a bridge.

17. The method for manufacturing a honeycomb structured body according to claim 15,
wherein
the material of said belt is rubber, urethane, vinyl chloride, fluororesin, or silicone resin.

18. The method for manufacturing a honeycomb structured body according to claim 11,
wherein
said storage unit can store the wet mixture in the amount of at least about 1.5 times and at most about 3 times higher, by weight, than the molding capability of an apparatus used in said extrusion molding.

19. The method for manufacturing a honeycomb structured body according to claim 11,
wherein
said wet mixture is stored for a fixed period of time, and the storing time is at least about 1 hour and at most about 10 hours.

20. The method for manufacturing a honeycomb structured body according to claim 19,
wherein
said storing time is in the range of about 4 hours to about 8 hours.
